(19) United States
(12) Patent Application Publication
(10) Pub. No.: US 2007/0042668 A1
(43) Pub. Date: Feb. 22, 2007

(54) Hand Held Launcher

(76) Inventor: Brian Lapointe, West Yarmouth, MA (US)

Correspondence Address: BRIAN LAPOINTE, 25 COTTAGE DRIVE, WEST YARMOUTH, MA, 02673, US

(21) Appl. No.: 11/161,821

(22) Filed: Aug. 17, 2005

(51) Int. Cl. A63H 27/00

(52) U.S. Cl. 446/57

(57) ABSTRACT

In accordance with the invention, there is provided a lightweight, hand held launcher for the purpose of furnishing children with a means of throwing safe objects, such as soft foam balls, a greater distance than would be possible with the bare hands alone. By combining the basic elements of a handle and a lever attached to a large, tapered, tubular shaped receptacle, a launcher is disclosed, which is both simple and safe for children to use. The invention enables a child to quickly and easily launch specifically sized objects, provided with the launcher, while making the launching of rocks, dirt, or other dangerous objects nearly impossible, since these types of items either do not fit inside the receptacle or pass through it and out the open bottom.

### FIELD OF THE INVENTION

This invention relates generally to outdoor, active play toys and more specifically to toy throwing or launching devices, commonly combined with items such as planes, rockets or parachutes, which require that a child provide a high altitude delivery of the toy for maximum enjoyment.

### DESCRIPTION OF THE PRIOR ART

For many years, children of all ages have enjoyed hours of entertainment provided by toys, such as planes, rockets and parachutes. A significant drawback associated with this category of toys, however, is the necessity to launch the items to an altitude, which is high enough to provide a long lasting visual experience. Any practical launching system must be inexpensive to manufacturer, since it is not the primary object of interest to the child, but rather a device which only facilitates the quality of the play experience. Any adequate launching system provided for children, must be lightweight, simple and intuitive to use, and incorporate design features which prevent or greatly inhibit the child's ability to launch unintended objects, such as rocks and other potentially dangerous projectiles. While many attempts have been made to provide children with an adequate launch device, a review of the prior art will clearly illustrate how past inventions have fallen far short in their efforts to provide a launcher which is safe and easy for children to operate, while exhibiting a satisfying level of performance.

U.S. Pat. Nos. 5,579,748 and 4,222,361 disclose hand held disc launching devices of different designs. Kohl describes a launcher which is certainly simple in form and relatively easy to use, however it can just as easily be used to launch small stones and other various solid objects that pose a serious danger to children. On the other hand, Jackson teaches a device which excels in the area of safety, but is very unintuitive and requires much more dexterity than most children would have acquired before their teen years.

In U.S. Pat. No. 5,398,665 Carlson sets forth a very massive launcher. Such a device would technically be illegal in most states, since it is nothing more than a very large slingshot, configured to launch objects in an upward direction. Children and adults alike risk fatal injury from large rocks which could be launched to dangerous heights with this device. U.S. Pat. No. 6,546,923 describes a similar type of launcher utilizing a much more complicated design. The Erickson device, however, incorporates no safety measures and threatens children with the same hazards posed by the Carlson invention.

U.S. Pat. No. 5,735,256 discloses what is described as a portable ball launching device. Perhaps a better description of this invention would be a manually operated baseball pitching machine. While the Monk invention is somewhat user friendly, it is obviously not intended for use by children, and like the inventions already noted, it lacks many features necessary to insure the safety of spectators.

In U.S. Pat. No. 3,983,660 Weeks discloses a launching device with parachute. This invention, which is certainly designed as a child's toy, is wonderful in its simplicity. Once again, however, we see how the issue of safety has been grossly overlooked. Throwing both a parachute and rigid weighted pole into the air, where the two separate and fall back to earth, requires that the operator and spectators alike avoid being hit in the head by the pole, while trying to enjoy the visual experience of the parachute.

It is quite obvious, that while inventions of the past have attempted to provide practical, effective, launching devices, none are teaching a device, which is safe and easy for children to use. There is a definite need for a launching device, which is specifically designed with the needs of children in mind. There exists a great need to provide an inexpensive, intuitive, hand held launcher, which will both enhance the quality of play and protect children from the inherent potential hazards of launching devices. It is therefore one object of this invention, to provide a simple, lightweight, hand held launcher, which is intuitive and safe enough for unsupervised children to use. It is another object of this invention to provide a hand held launcher, which addresses all of the safety requirements for a children's toy; especially those which prevent the launching of unintended, dangerous objects, which pose a serious risk to both users and spectators alike. It is a further object of this invention to provide a hand held launcher for children, which is inexpensive to manufacture, without compromising performance or safety. Other objects and advantages of this invention will become apparent from a consideration of the drawings and ensuing description.

### SUMMARY OF THE INVENTION

The foregoing and other objects of this invention are accomplished, by providing a hand held launcher comprising a very simple construction, thereby maximizing intuitiveness and eliminating the need for any moving parts. A hollow plastic handle, adapted for fitting comfortably into the hand of a child, is joined at one end to an elongated lever arm. The lever arm section is provided to increase the effective length of the user's arm, so that a swinging motion of the arm combined with a short snap of the wrist translates into a much faster and distant movement, of the launcher end opposite the handle. Similar physics are observed in the swinging of a tennis racquet or golf club, where the swinging motion of the arm combined with a snap of the wrist results in a much greater distance and speed at the head of the racquet or golf club. It is important for the lever section to be lightweight and to have some degree of structural rigidity in order to minimize energy absorption, which would otherwise take place if too much flexing of the lever were to occur. A hollow, tubular receptacle, which is completely open at both ends, is affixed to the lever section, near an end opposite to where the handle is attached. The interior of the receptacle should be smooth and unobstructed to allow for easy insertion and launching of lightweight objects. It is essential that the receptacle be both rigid and as light in weight as possible. Any flexibility in the receptacle may encourage the jamming of an object being loaded for launching and its subsequent difficult exit when a launch is attempted. If the receptacle is unnecessarily heavy, then the action of launching an object requires additional effort on the part of the user, which is especially troublesome for children with limited arm and wrist strength. The receptacle also comprises a slightly tapered or conical form. More specifically, the receptacle could be described as having a slightly tapered axial cross-section. This feature greatly limits the size of an object, capable of being fitted into the receptacle, since an object must achieve a frictional fit within the receptacle to prevent its passing through and exiting out of the opposite open end prior to launching. A high degree of safety is thereby achieved, because if a minimum diameter of the receptacle comprises a large non-standard size, there becomes a lesser chance that a common object, for example, a hard baseball which is not intended for use with the device, could achieve the frictional fit within the receptacle that is necessary to obtain a successful launch. In another example, since children do not have the physical strength required to launch a large rock from the end of a lever, and since smaller stones, dirt, sticks and many other hard, dangerous objects within the reach of children, pass through and out of the bottomless receptacle, the proposed invention again exhibits its means for adding an unprecedented degree of safety, to a hand held launching device made safe for use by children.

Lightweight objects of non-standard size, such as foam balls, flexible rockets and gliders, parachute toys and the like, can be packaged and sold for use with the proposed hand held launcher. Such objects would be loosely inserted into the bottomless tapered receptacle and be assured of achieving the necessary frictional fit. With an intended object loaded into the launcher's receptacle, a child, grasping the launcher handle, simply swings the launcher overhead, with a motion similar to that used when casting a fishing rod, to propel a safe object in either a horizontal or upward direction. With the proposed invention, it becomes possible for a child to launch soft balls and other various aerial toys a greater distance than would otherwise be possible with the arm and bare hand alone.

### BRIEF DESCRIPTION OF THE DRAWINGS

FIG. 1 is a side view of a preferred embodiment of the invention detailing handle adaptations, a lightweight yet structurally rigid lever arm design and a tapered profile of a receptacle.

FIG. 2 is a top view of a preferred embodiment of the invention illustrating additional handle adaptations and a bottom of an open ended receptacle.

### DETAILED DESCRIPTION

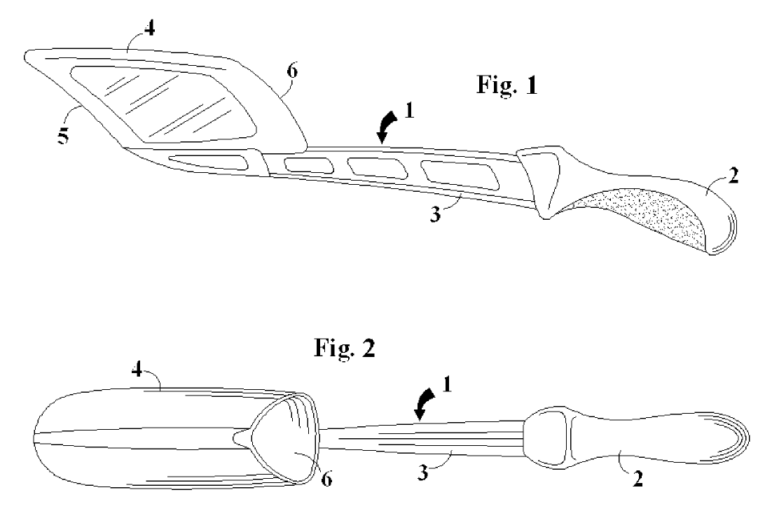

In the preferred embodiment, FIG. 1 discloses a side view of hand held launcher 1. Handle 2, composed of Styrene or similar plastic material, is manufactured by injection molding in two halves, which are then assembled by sonic welding, gluing or the use of screws. Lever arm 3, composed of styrene or similar plastic material, is also injection molded, but in one piece for added strength with minimal weight. When two halves of handle 2 are assembled, lever arm 3 is simultaneously joined at an end to handle 2 by being captured between the two halves, a method of assembly which is well known by someone skilled in the art of injection plastics manufacturing. The union of handle 2 with an end of lever arm 3 is made permanent by sonic welding, gluing or the use of screws. Receptacle 4, composed of Styrene or similar plastic material, is manufactured by injection molding in two halves, which are then assembled by sonic welding, gluing or the use of screws. Receptacle 4 is permanently joined to lever arm 3 at an end opposite handle 2, by sonic welding, gluing or the use of screws. Opening 5, oriented at a furthest point from handle 2, has a slightly larger radial cross-section than opening 6, such that receptacle 4 has a slightly conical axial cress-section overall.

What is claimed is:

1. A hand held launcher comprising, a handle means, said handle means adapted for fitting comfortably in a hand, said handle means joined at an end to a lever means, said lever means having at least a semi-rigid structure, said lever means joined at an opposite end to a receptacle means, said receptacle means having a forward portion and a rearward portion, said forward portion of said receptacle means positioned at a furthest point from said handle means, said receptacle means having a tubular form, said tubular form comprising a section of a cone, such that an area of a radial cross-section of said forward portion is slightly greater than an area of a radial cross-section of said rearward portion, said receptacle capable of slidably receiving and frictionally communicating with an outside dimension of an object at an inside dimension of said receptacle, said hand held launcher capable of launching said object when said handle means is fitted in said hand and forcefully rotated about an axis of rotation at a point within said handle means.

2. The launcher of claim 1, wherein said handle means and said lever means and said receptacle means comprise a continuous conical tube.

3. The launcher of claim 1, wherein said receptacle means is continuous with and comprises said lever means and is joined at an end having a smallest radial cross-section to said handle means.

4. The launcher of claim 1, wherein said receptacle means comprises a section of a tube, such that an area of a radial cross-section of said forward portion is equal to an area of a radial cross-section of said rearward portion.
